(19) United States
(12) Patent Application Publication
(10) Pub. No.: US 2006/0146780 A1
(43) Pub. Date: Jul. 6, 2006

(54) Trickmodes and speed transitions

(76) Inventor: Jaques Paves, Folsom, CA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 11/187,202

(22) Filed: Jul. 22, 2005

Related U.S. Application Data
(60) Provisional application No. 60/590,504, filed on Jul. 23, 2004.

(51) Int. Cl. H04B 7/212

(52) U.S. Cl. 370/348

(57) ABSTRACT

The disclosed embodiments contemplate techniques for communicating a data stream. The inventive techniques include determining a first timeslot of a first data stream and determining a second timeslot of a second data stream. If the second data stream is greater than the second timeslot, a portion of the second data stream is moved to the first timeslot. In addition, the techniques may include controlling an amount of data storage as a function of the moved portion. Also, the techniques may monitor a size of the second data stream and a size of the second timeslot.

### CROSS REFERENCE

This application claims priority to U.S. Provisional Application No. 60/590,504, entitled “Buffer Optimized Trickmodes and Speed Transitions,” filed on Jul. 23, 2004, and hereby incorporated by reference in its entirety.

### TECHNICAL FIELD

The disclosure generally relates to techniques for transmitting video data.

### BACKGROUND

Video frames may be used to represent data that is capable of being fast forwarded, rewound, paused, stopped and played. The amount of data transmitted or received associated with those video frames for a given time period or timeslot may be used to determine available bandwidth. One type of video frame may be referred to as a “trickmode” frame, which is used in many different video transmission methods.

Managing transmission of video frames in video transmission is one consideration in order to achieve desired video production quality. For trickmode frames, there may be unpredictably and variation in the amount of data associated with a given frame, which may contribute to management issues. For example, to ensure that a trickmode frame fits within an available timeslot, a timeslot technique may be used where each slot has a fixed amount of bandwidth large enough to transmit the largest trickmode frames. Bandwidth, however, may be unused for other shorter trickmode frame, where the timeslot is larger than required. This may result in an increased amount of unused bandwidth.

It is also often difficult to estimate the amount of memory needed to buffer trickmode frames before they are transmitted. As a result, at certain times the amount of data required to be buffered may be greater than available memory, causing a “buffer overflow” condition. The buffer overflow condition may result in various undesirable visual conditions, such as jump and jitter.

### BRIEF DESCRIPTION OF THE DRAWINGS

FIG. 1 provides an example video buffer level;

FIG. 2 provides an example technique that increases the length of a subject Group of Pictures;

FIG. 3 illustrates an effect of a sequence of video frames on a buffer level;

FIG. 4 provides a distribution curve for a video stream;

FIG. 5 provides an illustration of a trickmode packet adjustment;

FIG. 6 is a graphical depiction representing the effect of shifting a trickmode packet on buffer levels;

FIG. 7 illustrates how buffer optimization may be used to produce a trickmode stream;

FIG. 8 provides an output of a trickmode video stream;

FIG. 9 provides an illustration of a splicing technique;

FIG. 10 is a system for communicating a data stream;

FIG. 11 is a flow diagram of a method for communicating a data stream; and

FIG. 12 is a flow diagram of a method for controlling a data storage level.

### DETAILED DESCRIPTION

The disclosed embodiments provide techniques to achieve efficient bandwidth usage in communicating video data, like trickmode video streams, while maintaining buffer levels that provide desirable video playback conditions. It should be appreciated that while the embodiments are discussed in the context of Motion Pictures Expert Group (MPEG) techniques, the described techniques may also be employed with other types of data compression/decompression techniques.

In some video compression/decompression techniques, video may be divided into frames. For example, MPEG uses at least three different types of video frames: I-, P-, and B-frames. I-frames or “intra coded frames” include intra-frame macroblocks that may allow an I-frame to be decoded without any other previous or future frames in the sequence. For random playing of MPEG video, a decoder may start decoding from an I-frame. I-frames may be inserted every 12 to 15 frames and may be used to start a sequence, allowing video to be played from random positions and for trickmode features, like fast forward and reverse, for example.

P-frames are coded as differences from previous frames. A new P-frame may be predicted by taking a prior frame and predicting values for a new pixel of the current frame. P-frames may provide a higher compression ratio depending upon the amount of motion present.

B-frames or “bidirectional frames” are coded as differences from a previous or subsequent frame B-frames and may use previous and subsequent frames for accurate decoding. Thus, the order of the frames as read may not be the same as the displayed order. This means that a subsequent frame may be transmitted and decoded prior to the current B-frame, but presented after the current frame. For example, a display sequence of frames I₁ B₂ B₃ P₄ B₅ B₆ P₇ may be reordered and transmitted as I₁ P₄ B₂ B₃ P₇ B₅ B₆.

Sequences of MPEG video may include a Group of Pictures (GOP). Each GOP includes video frames. GOP structures are associated with the number of frames they contain (N) and the distance between two reference frames (M). For example, typical GOP structures may be IBBPBBPBBPBBPBBP, where N=15 and M=3 and/or IBBPBBPBBPBB, wherein N=12 and M=3. Of course, these structures may vary and some may include, for example, P-frame only streams, like PPPPPPPP.

A trickmode GOP is a video sequence containing an I-frame and a variable number of dummy B-frames and P-frames. The trickmode GOP size may be associated with the number of frames in a trickmode GOP. For example, a GOP structure of IBBPPP has a GOP size of 6. A timeslot of a GOP or trickmode packet may be a period that goes from the I-frame DTS (decode timestamp) to the following I-frame DTS.

A trickmode packet may be associated with a trickmode GOP, and may include data to tailor a valid transport stream. The trickmode packet may include a Program Allocation Table (PAT) table, a Program Map Table (PMT) table, transport stream packets that have Program Clock Reference (PCR) only (e.g., no data) for synchronization referenced as “Sync” packets, a trickmode GOP and filler null packets having variable size.

The size of a trickmode packet may be based on the trickmode packet itself. The size of the trickmode packet may also accommodate for storage overhead, network overhead, and bitrate control. For example, a file segment that includes an I-frame may also contain other packet identifiers or “PIDs” (e.g., PAT, PMT, audio) that are multiplexed at the transport stream level. The block may be read into memory, and non-video packets may be replaced by nulls (e.g., “muting”).

A trickmode packet may also be a multiple of 1316 bytes (e.g., MPEG2 transport stream over user datagram protocol or UDP).

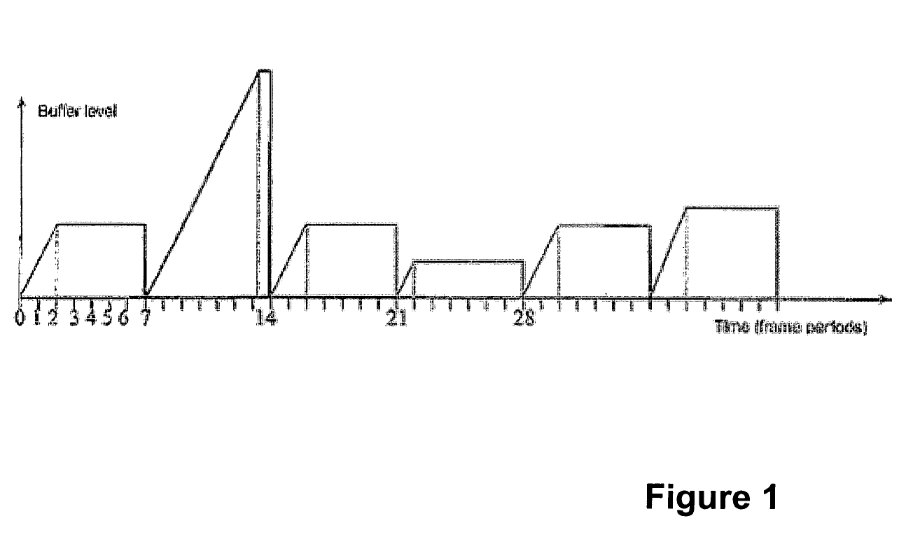

FIG. 1 provides an example video buffer level for I-frame-based trickmodes using fixed timeslot allocation. As shown in FIG. 1, each GOP includes 7 frames. Other sizes of GOPs may be used. The horizontal scale (t) depicted in FIG. 1 is given in frame periods (e.g., 1/30 second). For example, the “trickmode GOP” structure may be IBBPPPP or an I-frame followed by 2 dummy B-frames and 4 P-frames. This structure produces seven I-frames every 30 seconds, or 4.28 I-frames per second.

As illustrated by the dashed vertical line in FIG. 1, the first GOP is received at t=2. Because the GOP structure is set at seven frames, it is not decoded and presented until t=7. A second GOP structure is received at t=13. In this example, from t=7 until t=13, the decoder presents the first GOP, while the second GOP is being transmitted and buffered. At t=14, the second GOP is already buffered and ready to be decoded.

A GOP may be received before the interval at which it is ready to be decoded and presented, an interruption to the decoding process may not occur. However, because a GOP may be received before the interval at which it is ready to be decoded and presented, there may be unused bandwidth. This unused bandwidth is depicted as the cross-hatched rectangular area in FIG. 1.

One way to try to resolve the wasted bandwidth problem may be to send more I-frames per second, for example, by reducing the timeslots and/or GOP sizes. For example, referring to FIG. 1, reducing the GOPs to six frames would reduce the amount of unused bandwidth by the first GOP by one frame. However, the second GOP would not be ready to be transmitted until t=13.5, which is after it was to be decoded and presented. Because the second GOP takes about 6.5 frame intervals (i.e., 13.5−7) to be transmitted, the first GOP would cause in an incomplete second GOP presented to the decoder at t=12. Providing an incomplete second GOP to the decoder may cause “buffer underflow.” In one embodiment, the length of the GOP and timeslot may be a function of the size of the subsequent GOP. For example, as reflected by the sample distribution in FIG. 1, some I-frames may require timeslots as short as two frames, while others may be as long as six frames.

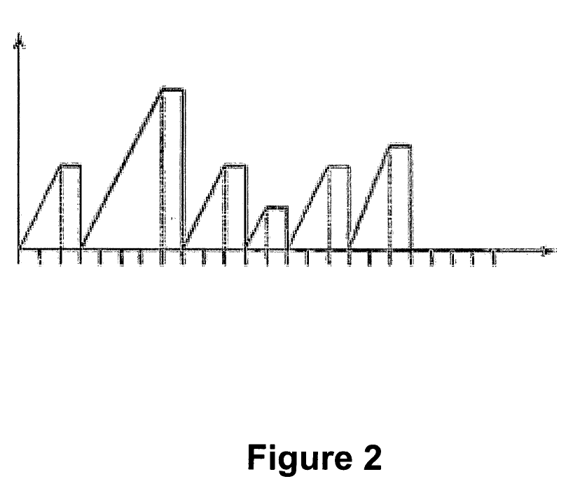

FIG. 2 provides an example technique that increases the length of the subject GOP based on the GOP that follows the subject GOP. As shown in FIG. 2, using the same GOP sequence, the amount of unused bandwidth (as indicated by the cross-hatched rectangular sections) may be reduced to just one interval length by making the total interval random for each GOP. In particular, the first GOP has a four frame interval, the second GOP has 5 intervals. The trickmode sequence generated may introduce new I-frames that are presented at random intervals.

The techniques illustrated by FIG. 1 and FIG. 2 may operate on the assumption that the video buffer will be empty after every GOP is decoded, because the buffer contains the remaining dummy P-frames and B-frames that have a negligible size.

A data ingest process may decode one frame every “N^{th}” frame received in order to generate an “N-speed” trickmode stream. For example, in order to generate an 8× stream, the ingest process may decode frames 1, 9, 17, 25 . . . (8n+1). These frames may then be used to generate a MPEG2 transport stream, such that the resulting stream may contain, for example, 30 unique frames per second. The sequence of frames may then be encoded into a new MPEG2 transport stream that may preserve some characteristics of the original transport stream, like frame rate, bitrate, PID assignment, video format, and video buffer characteristics (e.g., buffer size and buffer level for a smooth speed transition). This technique may offer greater trickmode quality. It also may use greater processor power and additional storage overhead (e.g., typically 30%).

In some embodiments, I-frame-based trickmodes also may insert dummy B-frames and P-frames. Also, in some of those embodiments, P- and B- frames may be encoded using frame prediction, which may result in frame jitter. For example, in those embodiments using broadcast television (i.e., National Television System Committee (NTSC)) each frame may be composed of two interlaced fields, giving a total of sixty fields per second. As a result of the difference between the 24 fps in movies and 30 fps frame rates to television, a “3:2 pulldown” method may be used to convert a movie into television content.

The “3:2 pulldown” method may convert a frame alternately into three and two fields. For example, 4 frames at 24 fps (i.e., 1 frame every 6 seconds) will produce 10 fields or 5 complete frames at 30 fps. When using interlaced mode for encoding (as compared to progressive mode), a frame will contain two fields - A at the top and B at the bottom. If frame prediction is used to generate dummy B-frames and P-frames, the decoder may copy both fields from the reference picture or I-frame. Therefore, for example, a trickmode GOP with the structure IBBPP would cause the decoder to produce a sequence of five fields (two AB for each frame) having the structure ABABABABAB.

An I-frame may contain fields that are originated from two different pictures, a sequence of fields ABABABABAB may cause an impression of “jitter.”

In certain embodiments, when initiating trickmode features, reference frames used by B and P-frames may be broken when copying those frames to the output stream. This may be due, in part, to the fact that trickmode files may be generated by picking one frame out of N frames. As a result, because the B and P-frames frames may no longer be present in the output stream, these frames with missing references have to be fully decoded and then re-encoded in the context of the trickmode stream, using different reference frames.

For example, a video frame sequence IBBPBBPBBPBBPBBIBBPBBPBBPBBPBBIBBP may be represented by IBBPBBP with respect to the trickmode sequence. B-frames that are in an original video frame sequence may depend on previous and subsequent I and P-frames that are not a part of the trickmode sequence file. Also, some frames may be encoded differently in the trickmode file, depending on where they are inserted in the sequence. For example, an I-frame in the original sequence may be encoded as a P-frame in the trickmode file and a B-frame may become a P-frame or even another B-frame with entirely different reference frames.

Typical bandwidth rates used in the cable industry include a 3.75 Mbits/s, 30 frames per second stream that is ingested at 3.75 Mbits/s, as described in the CableLabs™ Content Specification 1.0 [4]. For a video-on-demand (VOD) server that may require four trickmode files (e.g., speeds 15×, −15×, 60× and −60×), four encoders may be used to generate up to four different trickmode files in parallel by processing frames extracted and decoded from the original video stream.

Each trickmode encoder may receive at 2 frames per second (fps) (30/15), 2 fps (30/15), 0.5 fps (30/60), and 0.5 fps (30/60), for a total of 5 frames per second over all four encoders. Generally, using substantially all of the processing from, for example, a 2.4 GHz Pentium™ 4 processor allows for the encoding of 12 streams with an ingest bandwidth of approximately 45 Mbits/s. The resulting trickmode files will be respectively about 6.7%, 6.7%, 2.2% and 2.2% of the original file size for a total of about 16.6% storage. Therefore, in some embodiments, generating standard trickmode files may require a great deal of computer processing power and sophisticated computer logic. Moreover, the process may fully decode some frames, while others like B-frames may not be decoded.

I-frames may be used for random access mechanisms because displaying these frames does not depend on previous or subsequent frames. Therefore, for some embodiments, trickmodes may be used by merging I-frames into a newly created stream and inserting null packets to control bitrate.

The time to communicate an I-frame may be longer than a frame interval. For example, for an average I-frame size of 40 kb, an I-frame-only trickmode stream at 30 fps would require at least 9.8 Mbits/s (40 kb×8×30), or about 2.6 times the rate of 3.75 Mbits/s generally used in the cable industry.

In some embodiments, to preserve a higher frame rates such as at 30 fps, the I-frame rate may be reduced to about 10 I-frames per second. For example, rates may be preserved by inserting other frames in place of the remaining I-frames. For example, an I-frame may be displayed for two or more frame periods or intervals, allowing a subsequent I-frame to be transmitted and buffered. “Dummy” B-frames or P-frames that may be a copy of a last displayed frame may be inserted into the video stream. “Dummy” or duplicated frames, in one embodiment, may be “no-motion” frames having a reduced size as compared to an average I-frame size. Dummy frames may provide processor efficiency because they may be encoded at substantially the same time, and may be inserted in the output stream to extend the size of the GOP.

A trickmode stream with a rate of 10 I-frames/s, may be accomplished via the creation of “trickmode GOPs” or trickmode sequence of video frames. For example, a sequence of “trickmode GOPs” may be created with one I-frame followed by two dummy B-frames to create the following sequence: IBBIBBIBBIBBIBB, for example. If, for example, the size of the dummy B-frame is approximately 1.2 kb, the average bitrate of the output stream would be 3.5 Mbits/s ((40 kb*8*10 I-frames/s)+(1.2 kb*8*20 B-frames/s)), or within a maximum bandwidth rate of 3.75 Mbits/s.

In some embodiments, timeslot allocation and trickmode GOP sizes are adjusted dynamically in an I-frame-based trickmode stream to facilitate efficient bandwidth usage. The techniques further monitor video buffer utilization by detecting and preventing buffer overflows. In one aspect, “Dummy” P-frames may be inserted.

The techniques may also be used to maximize bandwidth utilization, while keeping buffer levels at minimum levels and increasing system responsiveness as processing speed changes. For example, in order to generate an 8× stream, the techniques may provide approximately 10 unique I-frames per second on average. The remaining frames (e.g., 20 frames per second in a 30 frame per second stream) may be dummy or non-motion B-frames and P-frames.

In one embodiment, the techniques are incorporated in a video stream software product. The techniques also may be accomplished using hardware, firmware or any combination thereof.

A video ingest stream may be parsed using a data structure. For example, a “Hinter” structure and the parsed data (i.e., I-frame and stream information) may be stored in a file called a “HINT” file. It should be appreciated that the video ingest may be conducted, for example, at approximately 300 Mbits/s by a typical Pentium 4™ 2.4 GHz processor. The HINT file may include a header that may be approximately 64 k. The HINT file also may include an I-frame table that is approximately 128 bytes per I-frame and may have a pointer to the location of the associated I-frame. A two hour-long movie at 3.75 Mbits/s having 2.0 I-frames/s (i.e., 14400 I-frames total) will produce a HINT file of approximately 1.9 Mbytes in size, which is less than about 0.06% of the original file size. However, because the trickmode may not be generated at ingest, the techniques, for example used in streaming software and/or hardware, may generate a trickmode stream dynamically.

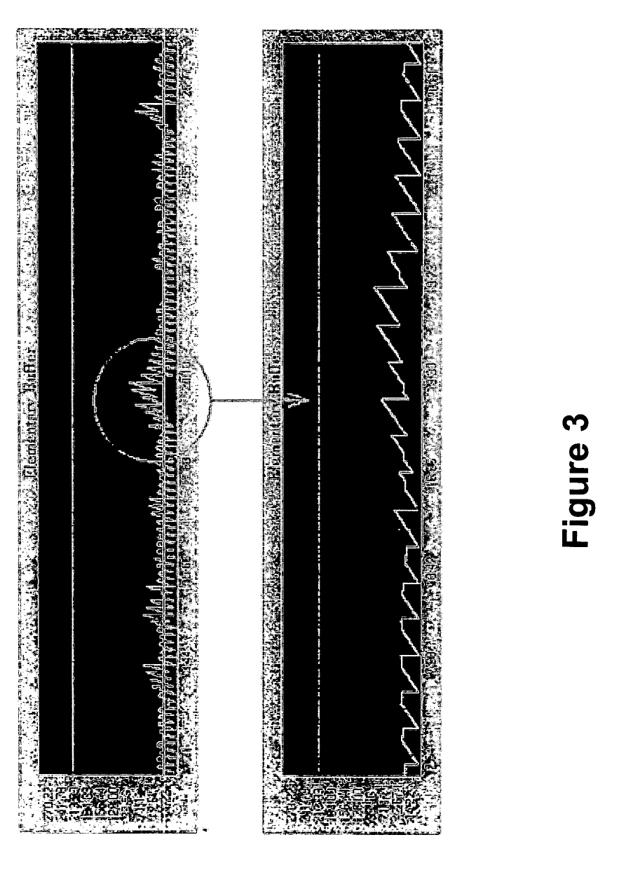

FIG. 3 illustrates the effect of a sequence of I-frames on the buffer level. The vertical axis represents decode times of the I-frames. As shown in FIG. 3, trickmode packets are “packed” by making use of buffering. A large sequence of I-frames may cause buffer levels to increase for a short period of time with little or no impact on the frame rate. Even though dummy P- and B-frames are also transmitted and decoded, they are about 30 times smaller than I-frames or approximately 1.3 k each.

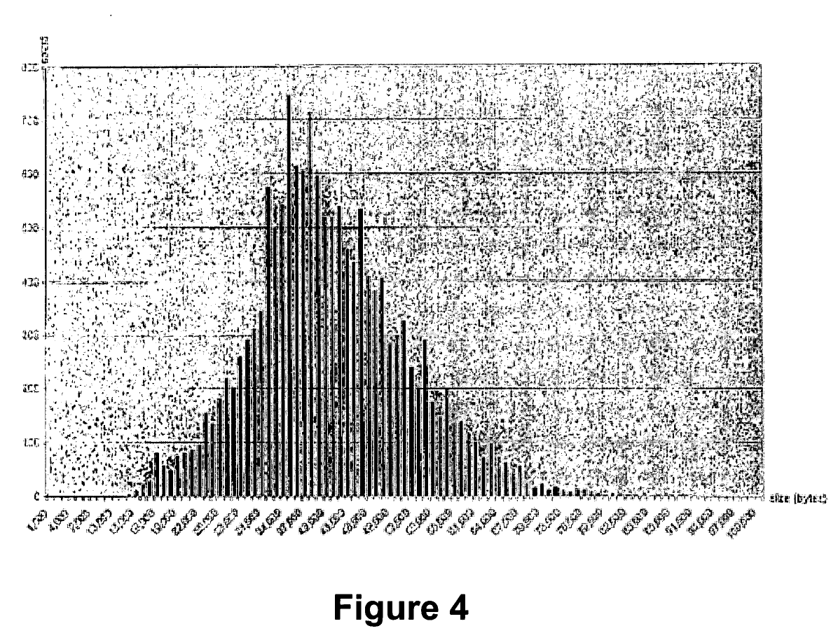

In some embodiments, the techniques used to adjust the buffer level may be derived from a fixed timeslot trickmode sequence. Such a sequence may be similar to the sequence discussed with reference to FIG. 1. Also, in order to achieve relatively greater visual quality, the techniques attempt to generate a substantially constant rate of I-frames. Although the video stream may include I-frames having any distribution, for the purposes of understanding and clarity, the following description assumes that the inputted video stream includes I-frames with a certain size distribution curve as depicted in FIG. 4.

The contemplated techniques may redistribute unused bandwidth in timeslots containing undersized I-frames to accommodate oversized I-frames. This may be accomplished, for example, by choosing an adequate trickmode timeslot size (i.e., based on GOP sizes) and selecting a large enough timeslot adjustment or window to ensure that a set of trickmode packets may be adjusted or rearranged without causing the buffer to overflow.

By rearranging the sequence of trickmode packets prior to transmission, bandwidth utilization may be improved. Also, the contemplated techniques may employ statistical averaging to accommodate the GOP size of any sequence of trickmode packets. In one embodiment, averaging may be accomplished by ensuring that the GOP size is less than or at least equal to the size of the packet adjustment.

As a result of this redistribution and rearrangement of I-frames out of their substantially fixed timeslots, the techniques may include decoding and associated buffering. Furthermore, managing the quantity of buffered data may be performed to prevent buffer overflow or underflow conditions.

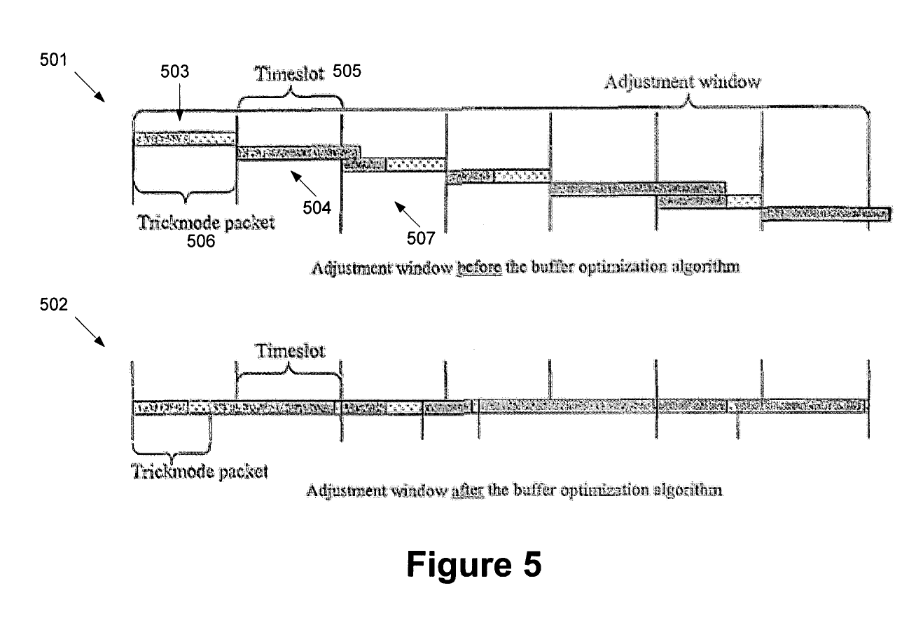

FIG. 5 provides an illustration of the trickmode packet adjustment. As shown in FIG. 5, upper window 501 illustrates how certain oversized trickmode packets may not fit in the fixed and available timeslots. For example, although trickmode packet 506 fits within the fixed timeslot 503, trickmode packet 504 does not fit within the subsequent timeslot 505. As a result, a portion of trickmode packet 504 runs over into timeslot 507.

Lower window 502 illustrates how the timeslots may be rearranged or reordered. Such rearrangement permits the use of available bandwidth or “nulls” from previous or subsequent trickmode packets to be used in larger trickmode packets.

The following discussion quantifies in mathematical terms the concepts described. It should be appreciated, however, that the disclosure is not limited to the manipulation or use of these equations. Instead, the following discussion is provided to gain a further understanding of the novel concepts, and the example equations offer just one possible approach contemplated by the embodiments.

For a data stream with bitrate br, frame rate fr, and a GOP size of q frames, the amount of data Q that may be transmitted in a give timeslot may be represented as follows:

$$Q = \frac{{qb}_{r}}{8 {f}_{r}}$$

The I-frame rate r may be calculated as:

$$r = \frac{{f}_{r}}{q}$$

It may be desirable in some circumstances to maintain q as an integer for better visual quality by providing a constant number of frames per GOP. Alternatively, q also may be allowed to vary (i.e., GOP size would vary) from GOP to GOP. Other possible embodiments may use an average value for q. For example, a value for q of 2.4 frames may be established for a sequence of GOPs having sizes 2, 3, 2, 2, 3 and providing 12.5 I-frames per second.

Applying the above equations for a video stream where br=3.75 Mbits/s, fr=30 fps, and q=3, allows 46,875 bytes to be transmitted in each timeslot with an I-frame rate of r=10 I-frames per second.

In order to estimate a bandwidth required for an adjustment window with n trickmode packets, an estimation of many aspects may need to be considered. For example, I-frames sizes, the number of dummy B-frames and P-frames and their sizes, and the size of the overhead data like PAT, PMT, PCR packets, and disk and network overheads may need to be considered. These values may be estimated. For example, it may be estimated that I-frame size in the original stream may have a certain size distribution (I, a,) that may not necessarily follow any particular distribution curve. Disk or storage overhead may be estimated in determining trickmode packet size.

The above estimations may result in an overestimation of the video buffer level by approximately 10%. As a result, in some embodiments, in a 40 KB block obtained directly from storage it may be necessary to transmit less than or equal to 36 kB of actual video data that will be stored in the video buffer. The remaining 4 kB may include other PIDs (e.g., audio, PMT, PAT) that are embedded in the block and have been “nulled” or “muted” before sending. Alternatively, the video data may be rearranged and about 36 kB of video data may be sent.

In order to ensure avoiding buffer overflow, the disclosed techniques may establish a limit a 90% of buffer capacity. This 90% limit also may prevent greater error in the described methods. The probability of the buffer level reaching 90% of its limit is relatively low because it requires a relatively large sequence of oversized I-frames in the trickmode sequence. Moreover, by overestimating the buffer levels, the probability of detecting buffer overflow is increased, yet without creating much degradation in the trickmode performance.

In determining the size of each I-frame in a sequence of n random I-frames, the total size

$${S}_{n} = {\sum }_{i = 0}^{n - 1} {I}_{i}$$

will be a random variable with distribution (nI, \sqrt{nσ₁}). The larger the value of n, the closer the random distribution (Sₙ) gets to the normal distribution. Any error resulting from this estimation may be corrected by P-frame insertion.

Furthermore, by estimating the size of the dummy P-frames and B-frames (P) and the overhead data (OH), the total amount of streaming data (Tₙ) contained in the adjustment window with n timeslots may be reflected by the following equations:
Tₙ=Sₙ+nOH+n(q−1)P=n(I+OH+(q−I)P)
σ_{T}=σ_{S}=\sqrt{nρ₁}
The bandwidth available in the adjustment window may be reflected by the following equation:
Qₙ=nQ=nqbᵣ/8fᵣ
In order to maximize the probability that the sequence of trickmode packets will fit within the designated adjustment window, the disclosed techniques, in some embodiments, may attempt to maintain a low probability of having to execute corrections ε, where ε>P(Tₙ>Qₙ) to a value on the order of 10⁻³.

Considering that n is large enough so that Sₙ may be considered a normal distribution, n may be large enough to satisfy the following equation:

$$erf ( \frac{{Q}_{u} - {T}_{n}}{{σ}_{T}} ) < ɛ$$

Inserting the following real values into the above equation: Bᵣ=3.75 Mbits/s, fᵣ=29.97 fps, q=3 frames, I=40491 bytes, σ_{T}=10835 bytes, P=1.0 kb, OH=2.0 kb, yields the following:

$${Q}_{n} = n \cdot \frac{3 \cdot 3.75 \cdot {10}^{6}}{8 \cdot 29.97} = 46921.92 \cdot n$$

$${T}_{n} = ( 40491 + 2048 + 2 \cdot 1024 ) \cdot n , {σ}_{T} = 10835 \cdot \sqrt{n}$$

$${T}_{n} = 44587 \cdot n , {σ}_{T} = 10835 \cdot \sqrt{n}$$

If ε=10⁻³, the adjustment window will be:

$$erf ( \frac{( 45922 - 44587 ) \cdot n}{10835 \cdot \sqrt{n}} ) < {10}^{- 3}$$

$$erf ( 0.1232 \cdot \sqrt{n} ) < {10}^{- 3}$$

$$0.1232 \cdot \sqrt{n} >= 3.08$$

$$n >= 625$$

Where the average size of an I-frame is just slightly below the chosen timeslot size, the described techniques allow a trickmode stream at about 10 I-frames per second. Also, in this example, the bandwidth utilization is approximately 97% (i.e., 44587 bytes divided by 45922 bytes). The actual bandwidth utilization percentage may be reduced by the need to make corrections due to buffer overflow (e.g., p-frame insertion).

The following example takes a different approach by choosing an adjustment window size and determining the maximum trickmode speed or minimum GOP size (q):

$${Q}_{64} = 64 \frac{q \cdot 3.75 \cdot {10}^{6}}{8 \cdot 29.97} = 1.001 \cdot {10}^{6} \cdot q$$

$${T}_{64} = ( 40491 + 2048 + ( q - 1 ) \cdot 1024 ) \cdot 64 , {σ}_{r} = 10835 \cdot \sqrt{64}$$

$${T}_{64} = ( 2.657 + 0.066 \cdot q ) \cdot {10}^{3} , {σ}_{r} = 86680$$

$$erf ( \frac{1.001 \cdot q - ( 2.657 + 0.066 \cdot q )}{0.086680} ) < {10}^{- 3}$$

$$\frac{0.935 \cdot q - 2.657}{0.086680} > 3.08$$

$$q > 3.127 frames$$

Here, the adjustment window size (N) is set to 64 samples E is 10-3 and the I-frame rate allowed is calculated. This may be accomplished by collecting statistics from the stream and calculating the maximum trickmode speed. The I-frame statistics may be stored in a “HINT” file associated with the stream, as previously discussed. The result of q=3.127 may be approximately 9.6 I-frames/second allowing for generating irregular GOP sizes, for example, 3, 3, 3, 3, 3, 4, 3, 3. In other embodiments, the result may be rounded up to the next integer q=4 resulting in 7.5 I-frames per second.

The buffer adjustment techniques may require a set of parameters to be calculated from each trickmode packet. These parameters may be directed to I-frame selection, I-frame data collection and initialization of control variables.

With regard to I-frame selection, a sequence of I-frames to generate a trickmode stream at certain speed (e.g., 15×, 30×, −1-× . . . ) may be determined. The I-frame sequence may be determined based on the speed (s), GOP size selected (q), and information extracted from the original stream, like frame rate (fᵣ) and average number of I-frames per second in the stream (Iᵣ). Iᵣ may be calculated as part of the hinting process, when the MPEG2 file is first ingested and stored in the HINT file.

The following example embodiment is provided for greater understanding. Assuming an average of 2 I-frames per second and a trick mode stream generated at 10 I-frames/s, if every I-frame is selected, the trickmode stream will be generated at speed 5×. If, alternatively, every other I-frame is selected (i.e., increment of 2), a trickmode stream at 10× may be generated. Selecting every other I-frame from the last to the first (reverse order, increment −2), gives a trickmode speed of −10×.

For a video stream having an average of I-frames/s (Iᵣ) with a trickmode speed (s), the index increment (i) floating point may be calculated as i=sqIᵣ/fᵣ. The index increment may be used to calculate a sequence of I-frame indexes (x), which are also variable. The actual I-frame may be obtained by rounding the sequence of indexes provided in the following example.

Iᵣ=2 I-frames/s, b=3 or 10 I-fps and fr=30 fps. If trickmodes are to be run at speed −16× (i.e., fast rewind) starting at I-frame number 600 (i.e., approximately five minutes from the beginning of a movie), the sequences of I-frame indexes would be 600 and I=3.2=−16×3×2/30. Therefore, the sequence of indexes produced is 600.0, 596.8, 593.6, 590.4, 587.2, 584.0. etc. Also, the sequences of I-frames selected for the buffer adjustment algorithm is 600, 597, 594, 590, 587, 584, etc.

Where the trickmode play speed is smaller, for example four times, the resulting index increment may be less than 1.0 and cause repeating frames. In these cases, the GOP size (q) may be modified during I-frame selection based on the calculated index increment. For example, using the values above, GOP size (q) may be modified to 3.75 and rounded up to 4.0. This may reduce the average number of I-frames per second from 10 I-frames per second to 7.5 I-frames per second. This places the index increment at about i=1.067.

It should also be appreciated that some embodiments may handle GOP size (q) as a variable or floating point, so that the index increment may be bounded to 1.0 and q may assume a non-integer value, for example, 3.75. This will produce a sequence of GOP with sizes of 4, 4, 4, 3, etc.

With regard to I-frame data collection, once the sequence of I-frames is determined, information regarding an I-frame may be collected and some data structures may be initialized (e.g., one or more per trickmode packet). The data may be obtained from the Hint file by simply pointing to the appropriate I-frame entry.

The following discussion provides some examples of the types of data information that may be used. “Start” data may be collected. Start data is the offset of the transport stream packet that includes the PES header associated with an I-frame. This may be the offset where the I-frame begins. “End” data also may be collected. End data may be the last offset of the I-frame in file. This is the offset past the last I-frame video data. It should be appreciated that between the start and end offsets, other non-video transport stream packets may be present in the file. These packets may be converted into nulls before streaming.

“Size” data also may be collected. Size data may be calculated as the difference (end minus start) that is the amount of data that may be sent that contains an entire I-frame. “Timecode” data also may be collected. Timecode data may provide interfaces with other components that eventually query the current timecode being streamed. The timecode may be found in the GOP header and extracted during the hinting process.

“File PCR” data also may be collected. File PCR data may be associated with the start offset to allow streaming software to perform PCR restamping. “File DTS” data may be collected and is associated with the I-frame in the original asset to perform DTS restamping and to perform smooth buffer transitions between regular play and trickmodes and back to regular play. “File PTS” data may be collected and is associated with the I-frame in the original asset to perform Presentation Time Stamp (PTS) restamping and to preserve the frame interval in all transitions.

“CC Start” and “CC End” data may be collected. CC Start data is transport stream continuity counter of the start packet. CC End is continuity counter of the end packet. CC Start and CC End data may be needed in some embodiments in order to perform CC restamping.

“Next field” data may be collected. With next field data, I-frames may be encoded using the “repeat first field” flag, so they contain three fields rather than two. In order to preserve the sequence of fields during transitions, a field adjustment mechanism may be used in the first dummy B-frame following a transition.

With regard to initialization of the control variables, it may be desirable to keep track of certain streaming variables. For example, stream offset, stream PCR, stream DTS, and stream PTS. The stream offset may be the total amount of data produced by the streaming software, which is different from the file offset. The stream PCR may be the actual PCR observed at the output stream, after the PCR restamping mechanism. Because the streaming software operates at a constant bitrate, stream offset increments may be associated with stream PCR increments.

Certain fields may be initiated. For example, “frames” is the number of frames, or may be the GOP size of the current trickmode packet. Initially set to the number q previously calculated, this number may be incremented as needed (e.g., p-frame insertion mechanism). If q is implemented as a floating point or variable, the number of frames may be calculated based on an error propagation mechanism shown below (i.e., q_error initated with value of 0):
Frames[i]−truncate (q+q_error);
Qerror=q+q_error−frames[i];
If q=2.6666 . . . , the sequence produced would be: frames={2, 3, 3, 2, 3, 3, etc.}

Packet size field represents the total packet size. The packet size may be based on the timeslot of the previous packet and may produce a non-integer number of TS packets. This may be corrected by means of an error propagation mechanism, which may take into account the excess from the previous trickmode packet. At this point a certain granularity to the entire trickmode packet may be enforced, such as 188 bytes (Transport Stream packet size) or 1316 bytes (MPEG2 over UDP packet size).

The first trickmode packet may be treated differently, depending on the state of the streaming engine. For example, if the streaming engine was inactive (i.e., pause and stop), there may be no risk for buffer underflow since the decoder is inactive. The packet size may be set to zero and available for modification by the adjustment technique. If, on the other hand, the streaming engine was playing, the first timeslot may be calculated based on difference between the DTS of the last frame displayed at normal speed and the current PCR. In other words, the first trickmode packet may be decoded after the buffer is substantially depleted from “normal play” data. This may be the “debuffering” technique used to transition from “Play” to “Trickmodes.”

In this instance, the sequence that calculates the trickmode packet size may be based on the timeslot of the previous packet (frames[j−1]*fᵣ). The packet size and packet excess may be floating points or variable and may be calculated as follows:

```
If(j=0 and StreamState=STOPPED) /* First trickmode packet after a full
stop */
  packet_size[j] = 0;
if(j=0 and StreamState=PLAYING) /* First trickmode packet after
playing */
  packet_size(j] = ((StreamDTS − StreamPCR)/27000000.0)*(bᵣ/8.0);
else
  packet_size[j] = (frames[j−1]/fᵣ)*(bₗ/8) + packet_excess[j−1];
  packet _excess[j] = packet size[j]−truncate)packet_size[j]/
  granularity)*granularity;
  packet_size[j] = packet_size[j]−packet_excess[j];
```

Packet excess may be a control variable used to enforce a certain granularity to trickmode packets, and may be used by the P-frame insertion technique to preserve the granularity when extending packet sizes. Data size may represent the total data size, including I-frame, dummy B- and P-frames, PAT, PMT and overhead associated with assembling the trickmode packet. Data_size may be calculated as follows: data_size[j]=sized[j]+(frames[j]−I)*P+OH.

“Bw_balance” may represent available bandwidth for buffer adjustment. This may be the difference between the packet-size and the data-size. Unused bandwidth may be filled with nulls, preserving the stream bitrate.

Minimum size of a trickmode packet may be imposed in some embodiments. This may be accomplished by making less bandwidth available for adjustment than the actual available bandwidth calculated. In some embodiments, hardware limitations, such as minimum “seek time” or minimum delay between trickmode packets that may be imposed by hardware constraints may be considered when determining the size of the trickmode packet. Also, these considerations may be included in the calculation of q, because it changes some assumptions about how trickmode bandwidth may be used.

In addition, a certain granularity may be imposed on the null packets that will be available for adjustment, for example, 1316 for transport stream over UDP packets. This may depend on a particular implementation of streaming software or hardware. The available bandwidth may be calculated as follows:

```
If(data_size[j]<min_size)
  then bw_balance[j] = packet_size[j] − min_size;
else
  bw_balance[j] = packet_size[j] −data_size[j];
if(bw_balance[j]<0)
  bw_balance[j] = granularity*(truncate(bw_balance[j]/granularity − 1);
else
  bw_balance[j] = granularity*truncate(bw_balance[j]/granulariry).
```

Bw_balance often may assume negative values representing an oversized packet. The negative value may be the amount of bandwidth missing for that trickmode packet that needs to be taken from other trickmode packets. This may be accomplished by balancing bandwidth required by large packets through using available bandwidth from small packets. The statistical analysis may be used to ensure that the overall balance of available bandwidth in the adjustment window is positive (Σ bw_balance[i]>0), depending on the parameter ε.

“Stream offset” may be the current stream offset expected for a packet. If the current packet is the first to be sent, that packet may be the stream offset taken from the streaming engine as discussed above.

```
if(j=0)
        stream_offset[j] = StreamOffset;
    else
        stream_offset[j] = stream_offset[j−1] + packet_size[J−1].
```

“Stream PCR” may be necessary for precise PCR restamping of video data retrieved from disk.

```
if (j=0)
    stream_PCR[j] = StreamPCR;
else
    stream_PCR[j] = StreamPCR[j−1] +
    round(27,000,000*packet_size[j−1]*8/bᵣ);
```

“Stream DTS” may represent the decode time of the I-frame to be sent as part of the trickmode GOP. DTS and PTS may be in the same time base as the PCR by multiplying them by 300. If there is a transition from play to trickmodes, the DTS may need to be corrected by half of a frame in order to allow field adjustment as described before. Otherwise, the trickmode packet DTS is calculated as:

```
if(j=0)
    stream_DTS[j] = StreamDTS;
else
    stream_DTS[j] = StreamDTS [j−1] +
    round(27,000,000*frames[j−1]/fᵣ);
```

“Stream PTS” represents the exact presentation time of the I-frame as follows

```
if(j=0)
    stream_PTS[j] = StreamPTS;
else
    stream_PTS[j] = StreamPTS[j−1] + round(27,000,000*frames[H]/fᵣ);
```

“Buffer level” may be the maximum buffer level at the decoder and may be achieved at the moment the last block of video data received by the decoder, at the offset given by: peak_offset[j]=strean\_offset[j]+data_size[j].

The buffer may include some dummy B- and P-frames from the previous GOP, and the maximum buffer level may be calculated as: bufferJevel[j]=size[j]+(frames[i]−1)*P+(frames[i−1]−1)*P. Considering that dummy B- and P-frames from the previous GOP are being consumed while the current trickmode packet is being transmitted, the actual buffer level may be less than the above value. The buffer level may be overestimated to guard against overflow. At the DTS of current trickmode packet (i.e., I-frame DTS), data from the previous GOP may have been consumed and the buffer level may be: bufferJevel[j]=size[j]+(frames[j]−1)*P.

FIG. 2 illustrates a decode buffer over time. The described embodiment may control the buffer level before the I-frame is decoded, at the instant given by DTS[j]. This is due to buffer adjustment causing the buffer level peak to move to this position. Because the size of dummy B- and P-frames from the previous trickmode packet may be relatively small, the formula with “Stream DTS” representing the decode time may be used without risk, especially because the I-frame size is overestimated as discussed. Alternatively, to ensure the buffer will not reach overflow, the formula where “Stream offset” is the current stream may be used.

As discussed, FIG. 5 illustrates how trickmode packets may be adjusted in order to rearrange the available timeslot intervals. As discussed, when the control variable bw_balance1[j] is negative, it indicates that the packet cannot be transmitted in its initially reserved timeslot. The inventive techniques shift and extend the packet size and consuming the available bandwidth from previous packets, while shortening the packet, as shown in FIG. 5.

An example of C code that shifts and extends the packet size and consumes the available bandwidth from previous packets, while shortening the packet may be as follows:

```
int bw_adjust;
for(int j=n−1; j>0; j−−)
{
  bw_adjust = bw_balance[j];
  if(bw_adjust<0)
  {
```

| | |
|---|---|
| packet_size[j] −= bw_adjust; | // Extends the packet to perfectly |
| | fit the trickmode data |
| bw_balance[j] = 0; | // No BW available, no BW |
| | needed |
| stream_offset[j] += bw_adjust; | // Shifts the packet to allow |
| | buffering before DTS is due |

stream_PCR[j] += 27000000*(bw_adjust*8/bitrate); // Adjust

the packet PCR

| | |
|---|---|
| packet_size[j−1] += bw_adjust; | // Shorten the previous packet |
| | by the same amount |
| bw_balance[j−1] += bw_adjust; | // Consume the BW from the |
| | previous packet |
| } | |
| } | |

This code segment may allow the available bandwidth to be rearranged in the adjustment window, and may ensure that the trickmode packets are completely transmitted before their decode time (DTS) is due.

In addition, it may be desired to consider buffer levels in addition to rearranging bandwidth. Also, in some embodiments, the first trickmode packet bw-balance[j] may be negative, and because it is the first packet in the sequence there is may be no previous packet from which to allocate bandwidth. P-frame insertion and transition techniques may be used as described below. Moreover, while the control techniques calculate parameters of each trickmode packet, it may not necessarily generate the stream. This may be accomplished by a streaming engine that uses the adjustment techniques to generate the trickmode stream.

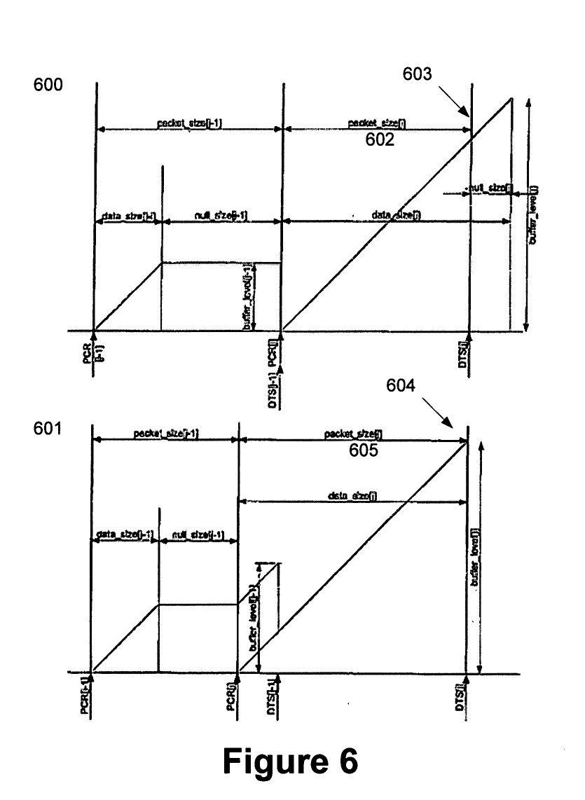

FIG. 6 is a graphical depiction representing an effect of shifting a trickmode packet on the buffer levels. Although FIG. 6 discusses the effect on buffer level with respect to shifting a trickmode packet, it should be appreciated that other bandwidth control techniques as well as other data manipulation techniques may require buffer control in some embodiments.

As shown in FIG. 6, a top window 600 reflects the buffer level before the trickmode packet is shifted, while a bottom window 601 reflects the buffer level after the trickmode packet is shifted in accordance with bandwidth control. As indicated in the top window 600, the packet 602 is not fully received until after DTS at point 603 (i.e., when the decode time is due). Shifting the trickmode packet may create a maximum buffer storage level 604 at DTS. Moreover, the maximum buffer level may be equal to the amount of data in the trickmode packet 605 that has been shifted. The difference (data-size[j]_packet_size[j]) may be ready at the decoder buffer at the instant DTS[j−1] in order to allow full buffering of the trickmode packet before it can be decoded.

The following code may be just one example of estimating maximum buffer level:

```
int bw_adjust;
for(int j=n−1; j>0; j−−)
{
  bw_adjust = bw_balance[j];
  if(bw_adjust<0)
  {
```

| | |
|---|---|
| packet_size[j] −= bw_adjust; | // Extends the packet to perfectly |
| | fit the trickmode data |
| bw_balance[j] = 0; | // No BW available, no BW |
| | needed |
| stream_offset[j] += bw_adjust; | // Shifts the packet to allow |
| | buffering before DTS is due |

stream_PCR[j] += 27000000*(bw_adjust*8/bitrate); // Adjust the

packet PCR

| | |
|---|---|
| packet_size[j−1] += bw_adjust; | // Shorten the previous packet by |
| | the same amount |
| bw_balance[j−1] += bw_adjust; | // Consume the BW from the |
| | previous packet |
| buffer_level[j−1] −= bw_adjust; | // Estimate Buffer level at the |
| | previous packet |
| } | |
| } | |

Buffer levels may increase each time an oversized frame is sent (i.e., a frame with size above the reserved timeslot). Buffer overflow may occur when adjusting a long sequence of oversized frames. Once an amount of data larger than the available timeslot is determined, it may be desirable to take action to accommodate the buffer overflow. This may be accomplished using any number of techniques. The following examples are not meant to be exclusive of all techniques contemplated by the embodiments.

One technique for handling buffer overflow may include P-frame insertion. P-frame insertion adds P-frames and thus extends the size of a previous GOP in order to generate additional bandwidth. Inserting additional P-frames may be accomplished in a number of ways. One technique for inserting P-frames to generate additional bandwidth will be discussed. However, the disclosed embodiments are not limited to this approach. One example is as follows.

A trickmode stream having a 3.75 Mbits/s video stream with a large trickmode packet may require six frame periods to be transmitted. However, it may be that the timeslot is only four frames as determined by the GOP size of the previous packet. As discussed above, the packet may be shifted and extended by two frame periods to accommodate the additional periods for transmission. As discussed, shifting the trickmode packet two frames may cause an increase in the peak buffer level of the previous packet by approximately 30 kb. For a video buffer size of 100 kb and a previous packet size of 90 kb, trying to buffer another 30 kb would cause a buffer overflow.

Dummy P-frames may be added in one embodiment. For example, if two extra P-frames are added, where each is approximately 1 kb per P-frame, the previous GOP size may be increased to six. The buffer level is increased only by 2 kb up to 92 kb and still within the 100 kb limits. By adding the two additional dummy P-frames to the previous GOP, the current packet size may be extended to allow the entire “oversized” packet to be transmitted. In other words, this technique holds the previous frame in the screen for an extra two frame periods, allowing the oversized frame to be completely transmitted. Moreover, because each additional P-frame that is inserted may extend the subsequent trickmode packet by about one frame period, additional bandwidth may be obtained. In this example, each approximately 1 kb of dummy P-frame generates about 15 kb of bandwidth, which represents the amount of data that can be transmitted in one frame period.

Also, by inserting a dummy P-frame the overall I-frame rate may be reduced and the adjustment window may be extended one frame. A code segment example capable of inserting an extra frame every time a buffer overflow is detected is shown below.

```
  int bw_adjust;
  for(int j=window−1; j>0; j−−)
  {
    bw_adjust = bw_balance[j];
    if(bw_adjust<0)
    {
```

| | |
|---|---|
| packet_size[j] −= bw_adjust; | // Extends the packet to perfectly fit the trickmode data |
| bw_balance[j] = 0; | // No BW available, no BW needed |
| stream_offset[j] += bw_adjust; | // Shifts the packet to allow buffering before DTS is due |

stream_PCR[j] += 27000000*(bw_adjust*8/bitrate); // Adjust the packet PCR

| | |
|---|---|
| packet_size[j−1] += bw_adjust; | // Shorten the previous packet by the same amount |
| bw_balance[j−1] += bw_adjust; | // Consume the BW from the previous packet |
| buffer_level[j−1] −= bw_adjust; | // Estimate buffer level at the previous packet |

```
      /* perform p-frame insertion until the buffer overflow is fixed */
      while(buffer_level[j−1]>video_buffer_level)
      {
        double increment;
        // Insert a P-frame in the packet where the overflow was detected
```

| | |
|---|---|
| frames[j−1]++; | // Insert a p-frame in the previous packet |
| data_size[j−1] += P; | // Account for an extra p-frame... |
| bw_balance[j−1] −= P; | // Take it from the bandwidth balance |
| buffer_level[j−1] += P; | // Update the buffer level estimation |

/* Use all the bandwidth created to revert the buffer overflow */

| | |
|---|---|
| increment = (1/frame_rate)*(bitrate/8); | // Calculate the amount of bandwidth created |
| packet_size[j−1] += increment; | // Restore the packet size (bw insertion in here!!) |
| bw_balance[j−1] += increment; | // Restore the bandwidth (and here!!) |
| buffer_level[j−1] −= increment; | // Restore the buffer level |

```
        /* Shift the current and subsequent packets by one frame */
        for(int k=j; k<window−1; k++)
        {
```

| | |
|---|---|
| stream_offset[k] += increment; | // Move packet back |
| stream_PCR[k] += 27000000*(increment*8/bitrate); | // Move packet back |

```
      stream_DTS[k] += 27000000/frame_rate; // Account for an extra frame
      stream_PTS[k] += 27000000/frame_rate; // Account for an extra frame
    }
    /* End of the p-frame insertion algorithm */
  }
}
```

Some embodiments also may be concerned with analyzing the granularity of trickmode packets that may, for example, be at least one transport stream packet (e.g., typically 188 bytes). The bandwidth created by inserting a P-frame may be determined by the following equation:
increment=(b/8)*(1/fᵣ);

In the example above, the increment is 15,625 bytes. Because each trickmode packet size was originally determined using error propagation techniques, a similar approach may be considered to calculate a more precise amount of memory. For example, this may be determined for a trickmode GOP size is q=4, a video buffer size of 110 kb, and trickmode data sizes of 25 kb, 90 kb, 40 kb, 70 kb, 80 kb, 80 kb, and 80 kb with a packet granularity of 1316 bytes (e.g., seven transport stream packets in a single UDP packet).

The calculated timeslot is 62,500 bytes=4*15,625 bytes. Therefore, the error propagation technique may generate the following sequence of packet sizes 61852, 61852, 63168, 61852, 61852, 63168, and 61852. The technique also may generate packet offsets of 0, 61852, 123164, 186332, 248184, 310036, and 373204 with bw_balance values of 35532, −31584, 21056, −10528, −21056, −19740, and −21056. Applying the buffer adjustment techniques starting from the last packet (index 6, 0-based indexes) where buffer levels are initially estimated as the same as the trickmode data sizes, the null sizes may be calculated as the difference (packet_size minus data_size), as shown below (note: timestamps will be omitted at this time (PCR, DTS, PTS)):

| packet_size[6] −= bw_balance[6] => packet_size[6] | | = 61852 + 21056 = 82908 |
|---|---|---|
| bw_balance[6] = 0; | | |
| stream_offset[6] += −21056 | => stream_offset[6] | = 373204 − 21056 = 352148 |
| packet_size[5] += −21056 | => packet_size[5] | = 63168 − 21056 = 42112 |
| bw_balance[5] += −21056 | => bw_balance[5] | = −19740 − 21056 = −40796 |
| buffer_level[5] −= −21056 | => buffer_level[5] | = 81920 + 21056 = 102976 |

In the second stage, the following may take place:

| | | | |
|---|---|---|---|
| packet_size[5] −= bw_balance[5] | => packet_size[5] | = 42112 + 40796 | = 82908 |
| bw_balance[5] = 0; | | | |
| stream_offset[5] += −40796 | => stream_offset[5] | = 310036 − 40796 | = 269240 |
| packet_size[4]+= −40796 | => packet_size[4] | = 61852 − 40796 | = 20876 |
| bw_balance[4] += −40796 | => bw_balance[4] | = − 21056 − 40796 | = −61852 |
| buffer_level[4] −= −40796 | => buffer_level[4] | = 81920 + 40796 | = 122716 (buffer overflow!) |

At this point, an extra dummy P-frame may be inserted on trickmode packet 4, so its GOP size changes to 5. Assuming a P-frame size of 1316 bytes, provides the following sequence:

| | | |
|---|---|---|
| (P -frame insertion) | | |
| frames[4] = 5; | | |
| data_size[4] += 1316 | => data_size[4] | = 81920 + 1316 = 83236 |
| bw_balance[4] −= 1316 | => bw_balance[4] | = −61852 − 1361= −63168 |
| buffer_level[4] += 1316 | => buffer_level[4] | = 122716 + 1316= 124032 (looks a little worst, but wait!) |

The following additional bandwidth may be provided due to the inserted P-frame:

| | | |
|---|---|---|
| (P -frame insertion) | | |
| frames[4] = 5; | | |
| data_size[4] += 1316 | => data_size[4] | = 81920 + 1316 = 83236 |
| bw_balance[4] −= 1316 | => bw_balance[4] | = −61852 − 1316 = −63168 |
| buffer_level[4] += 1316 | => buffer_level[4] | = 122716 + 1316 = 124032 (looks a little worst, but wait!) |

(Add bandwidth thanks to the P-frame inserted)
increment = (1/30)*(3750000/8) = 15625

| | | |
|---|---|---|
| packet_size[4]+= 15625 | => packet_size[4] | = 20876 + 15625 = 36501 |
| bw_balance[4] += 15625 | => bw_balance[4] | = −63168 + 15625 = −47543 |
| buffer_level[4] −= 15625 | => buffer_level[4] | = 124032 − 15625 = 108407 (overflow is fixed!) |

(Propagates the frame insertion to subsequent packets)

| | | |
|---|---|---|
| stream_offset[5] += 15625 | => stream_offset[5] | = 269240 + 15625 = 284865 |
| stream_offset[6] += 15625 | => stream_offset[6] | = 352148 + 15625 = 367773 |

In embodiments where granularity is a concern, packet sizes may be recalculated based on the new GOP sizes using the same error propagation technique described above with respect to packet_size.

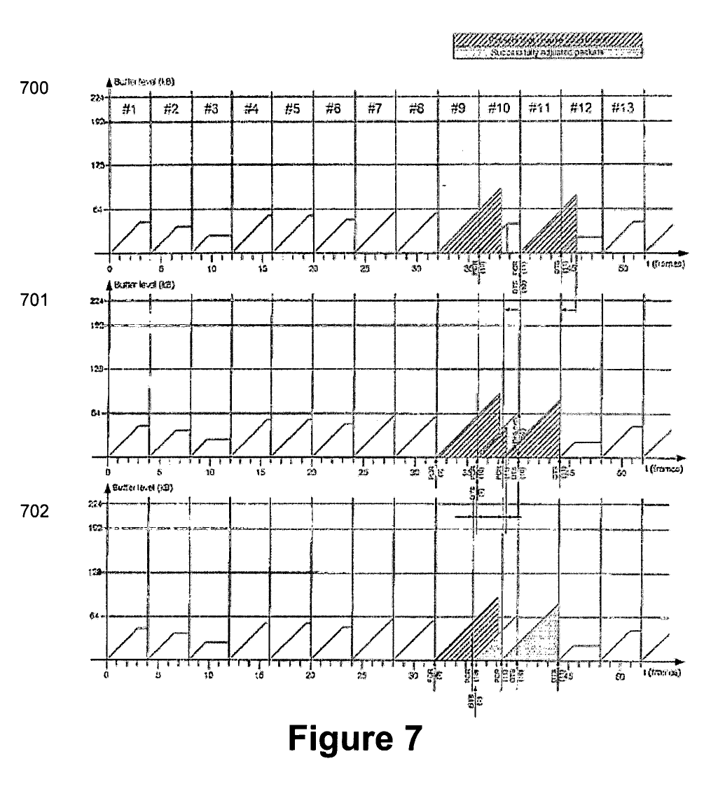

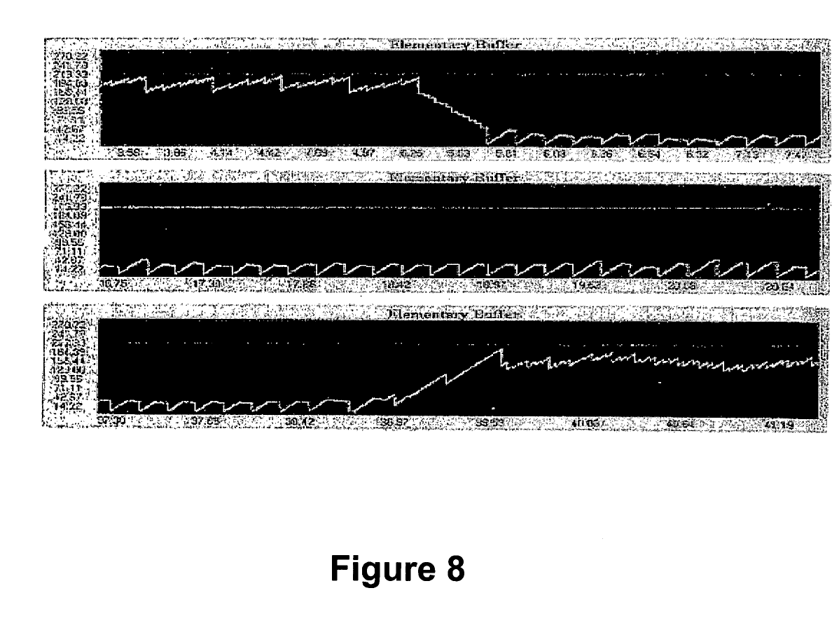

FIG. 7 illustrates how buffer optimization may be used to produce a trickmode stream. As shown in FIG. 7, packets that require adjustment are shown cross-hatched, while successfully adjusted packets are shown dotted. The top window 700 shows the trickmode packets as they are first calculated, and before the buffer optimization techniques are employed. The second window 701 shows how the last oversized frame is extended and shifted, causing the previous frame to have its available bandwidth consumed. The second window 701 also shows how shifting the same packet may effect the buffer level. The third window 702 illustrates the successfully adjusted packets. FIG. 8 provides an example output of a trickmode stream generated using these techniques.

It should be appreciated that I-frame based techniques may work in “low delay” mode, so buffer levels are kept low at the decoder. In order to resume the movie at normal play, the decoder may buffer from 0.5 s to 1.0 s of data. The difference in buffer levels may cause buffer underflow, which may cause the screen to roll or flicker, or even go black for a while.

File-based trickmodes may switch between trickmode files and regular files. This technique may require buffer levels to match at the transition points, and therefore buffer levels may be controlled when trickmode files are generated. Additional logic may be added to adjust the buffer levels at the transition point.

In one embodiment, when resuming normal play, the buffer management technique may act to modify the last trickmode frames (typically 2-4 frames) by increasing buffer levels for a more precise transition. This so-called “splicing” technique may reduce the speed of the last frames, creating a bandwidth in excess that may be used for rebuffering, and allowing video buffers to return to normal level. This technique may be implemented in a way that does not interrupt the sense of motion, so the transition is relatively seamless.

In order to start playing trickmodes after a play sequence, the play data that may be stored in a video buffer is consumed by the decoder. This occurs when the trickmode stream starts being decoded, and the data present in the video buffer is the data generated by the trickmode streaming engine. The first trickmode packet may be sent having its DTS set to the DTS of the last frame being played plus a frame interval. Also, the PTS may be set to the PTS of the last frame displayed plus one frame. If the “repeat first field” flag of the last frame is set to 1, PTS and DTS are incremented by a half of a frame period.

The de-buffering techniques may be implemented by setting the first trickmode packet size as the amount of data that can be transmitted from the current position (PCR) to the time the play buffer is empty and the first trickmode frame is expected (e.g., DTS as described above) using the following equation: frame_size[0]=((SrreamDTS−StreamPCR)/27000000.0)*(bI/8).

It should be appreciated that some video streams (e.g., MPEG2) may use some special flags “repeat first field” and “top field first” as a method of performing 3:2 pulldown. In order to preserve field continuity in those streams, the certain techniques may be applied in the transition sequence.

For example, one technique may be used where the last frame displayed has its “top field first” set to 0 (bottom first) and its “repeat first field” set to 0. This indicates that the last frame finished displaying the top field. If the last frame has its “top field first” set to 1 (top first) and its “repeat first field” set to 1, it also may indicate that the last field displayed was the top field. In either case, the next expected field may be the bottom field. Because these techniques assume the “top field first,” a field adjustment frame may be inserted.

These techniques may be performed by setting the “top field first” flag to 0 and “repeat first field” flag to 1 in the very first trickmode frame, which may be a Dummy B-frame. The sequence (bottom, top, bottom) not only preserves the field sequencing from the play sequence but also may allow a subsequent frame to start with the top field.

This field adjustment technique extends the GOP size by half a frame (i.e., one field). In order to ensure that all I-frames read from disk have the proper field sequencing, the “top field first” flag may be set to 1 and the “repeat first field” flag may be set to 0 in the I-frames, through a restamping technique that takes place after the I-frame is read from disk into memory.

In some embodiments, when the play sequence operates at a relatively low buffer level, there may not be enough time to transmit the first trickmode packet. By the time the last frame from the play sequence is consumed, the first trickmode packet may still be in the process of being transmitted. One solution is to append a sequence of P-frames to the beginning of the trickmode packet, similar to the P-frame insertion techniques. These P-frames may not be a part of the trickmode GOP, but extend the previous GOP (i.e., play sequence) and cause the decoder to repeat the last picture for a few frame intervals, so that the trickmode packet may be fully transmitted.

In addition, the method used to transition from trickmodes back to normal play may be accomplished by extending the last GOPs of the trickmode sequence to create extra available bandwidth. The available bandwidth may be used for rebuffering video data from a new play sequence, for example, operating in high delay mode.

The rebuffering technique attempts to hold the last trickmode packet long enough that the buffer can store the new play sequence while the decoder is busy playing dummy P-frames. The rebuffering technique may gradually create the bandwidth by increasing the GOP size of the last trickmode packets. If the GOP size selected is 4, it means that the last trickmode packets will have GOP sizes 5, 7, 10, etc. causing a visual impression of slowing down rather that a total stop.

The last trickmode packets may be inserted until the total available bandwidth matches or passes the necessary bandwidth to allow full rebuffering of the play sequence. The I-frame selection mechanism also may change for the last trickmode packets. This may be necessary in order to avoid going too far from the requested play offset. The index increment may be set to a minimum of 1.0 so that each transition trickmode packet will only move the stream about 1/Iᵣoff the requested position. Typical results indicate that approximately 3 to 5 transition packets are necessary to allow rebuffering, which represents only 1.5 to 2.5 s off the requested play position in a stream with Iᵣ=2 I-frames/s.

Another approach may be to compute the available bandwidth of a sequence of trickmode packets starting from the precise play offset, but going backwards, using index increment of −1.0. When the net bandwidth matches or passes the necessary bandwidth, the last packet will be the first packet used in the transition sequence. This technique may ensure that the transition sequence ends at the requested play offset.

In the same technique, if trickmodes are played at a negative speed (i.e., REW), I-frames may be selected from the forward direction (increment +1.0) until there is enough bandwidth available. The sequence of transition packets may then be taken from the current position, backwards to the position where the actual play sequence starts. Once the sequence of transition trickmode packets is determined and loaded into the buffer optimization technique, a “virtual trickmode packet” may be inserted in the adjustment technique with data size set to 0, trickmode packet size set to 0, but bw_balance set to the amount of data needed for buffering.

Using the buffer optimization technique may cause the available bandwidth of the trickmode packets to be consumed and shifts the transition packets, creating space for a new play sequence. This technique may cause a buffer transition as shown in the bottom graph of FIG. 8, where 4 transition packets may be observed with GOP sizes 6, 7, 8 and 9. Transitions from trickmodes to play using this approach may cause an impression of“slowdown,” without interruption of the frame sequence.

Fast Forward and Rewind may utilize the techniques described above. In this instance, a Video-on-Demand (VOD) server may receive feedback from a set-top box when a user releases the FF button, for example. However, the server's buffer management algorithm may build in a lag during the transition back to normal play. In order to fill up the buffer, the number of frames coming in may exceed the number of frames being played, so it may step up the transmission of frames to fill up that buffer after it receives the signal from the user. At that point, it may switch to a normal stream.

The techniques may reduce the speed of the last frames by generating a few extra B- and P-frames, which are relatively small, easily generated, and can be transmitted in less time than they are displayed, so that they fill up the decoder's buffer. “Slowing down” may represent sending less I-frames per second, and thus there is not impact to the actual frame rate, which typically must be constant 30 fps. By increasing the number of B- and P-frames sent along with every I-frame (which are relatively small), the average bitrate may be reduced by the trickmode techniques. The bandwidth in excess may then used to restore the buffer to normal levels.

In some instances, Pause and Resume may not use the above described techniques, because these modes are a transition utilizing the normal transport stream. Jump, on the other hand, may require buffer adjustment because buffer levels may be different at the transition point. Also, the same techniques applied to trickmodes may be applied to jumps, either by allowing debuffering or by inserting dummy B-frames and P-frames to allow rebuffering. Because buffer control is related to adequate adjustment of stream parameters such as PCR, DTS and PTS, speed transitions as well as jumps may need to be implemented by ensuring that these control variables match.

When the buffer level after the transition point is lower than the buffer level before, a sequence of nulls may be inserted to allow the buffer levels to get to adequate levels. This technique preserves the difference (DTS minus PCR) of the original stream after the transition. The decoding of the new sequence starts about one frame after the last frame of the previous sequence has been decoded. In order to avoid interruption in the sequence of frames, the PTS of the first packet after the transition may occur one frame after the last frame of the previous sequence have been displayed

The jump techniques may also take into account that some GOPs may be open. In other words, the first B-frames to be displayed before the I-frame in the new play sequence may use forward reference to a frame from a previous GOP that has not been transmitted. In addition, the jump techniques may correct field sequencing to avoid the presence of 2 top fields or 2 bottom fields in sequence. Wrong field sequencing may cause the screen to undesirably roll in a set-top box, for example.

The jump techniques may include a splicing method that ensures that the previous GOP was completely sent, avoiding incomplete pictures or sequences to be present at the decoder receive buffer. Also, the splicing method may determine that the DTS minus PCR of the new sequence is less than the current stream DTS minus PCR (i.e., from the old sequence), so the buffer level must decrease. In addition, the splicing method may retrieve the I-frame and append a sequence of dummy B-frames. The number of dummy B-frames may match the number of B-frames found in the original sequence prior to the I-frame. This may serve to avoid the problem described with respect to open GOPs.

The splicing technique may adjust the field sequencing by setting the “top field first” and “repeat first field” flags appropriately in the first dummy B-frame. If field adjust is necessary, DTS and PTS may be adjusted accordingly. In this instance, the new play sequence may be composed of an I-frame, dummy B-frames may then be restamped to match the remaining of the new play sequence (PBBPBBP, etc.) avoiding discontinuities. The splicing method calculates the amount of nulls that may be inserted in order to adjust buffer levels using the following equation:
nulls=(br/8)*((StreamDTS−StreamPCR)−(DTSnew−PCRnew))/27000000.0.

The splicing technique may calculate the restamping offset that must be added to the new sequence in order preserve stream continuity using the following equation:
PCR_restamp=(StreamPCR+(nulls*8/br)*27000000.0)−PCRnew

Streaming data following the transition point may be restamped by adding the PCR_restamp amount to the PCRs and the amount (PCR-restamp/300) to the DTSs and PTSs found in the elementary streams associated with the program, including audio.

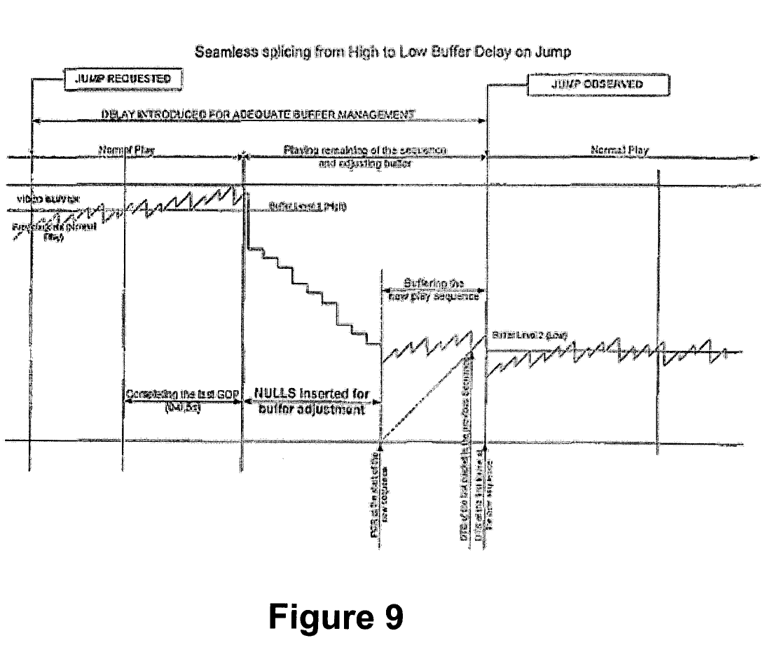

FIG. 9 provides an illustration as to how the splicing technique operates. When the buffer level at the new sequence is higher than the buffer level at the previous sequence, another technique may be employed. For example, a similar process described in the P-frame insertion technique and in the transition from trickmodes to play can be used to “freeze” the last picture, allowing the new sequence to be buffered.

The rebuffering technique may include inserting a number of P-frames followed by a short sequence of null packets. If the new sequence is transmitted right after the end of the previous sequence, starting at StreamPCR, the first frame may be decoded at instant given by StreamPCR+(DTS_{a-w}−PCR_{new}). The first frame of the new sequence is expected to be decoded at the instant given by StreamDTS, which is one frame after the last decode time from the previous sequence. Expressed as an equation, this is if StreamPCR+(DTS_{new}−PCR_{new})>StreamDTS, or (DTSnew−PCRnew)>(StreamDTS−StreamPCR), then there is an interval where the decoder stops decoding (i.e., buffer underflow).

It should be appreciated that field predicted no motion P-frames and B-frames or dummy frames may be encoded with picture structure as “frame,” and macroblocks encoded with prediction type as “field.” This may be accomplished where the P-frames macroblocks are encoded with “top field” forward referencing the “top field” with motion vector=(0,0), and “bottom field” forward referencing the “top field” with motion vector=(0,0). B-frame macroblocks may be encoded with “top field” backward referencing the “top field” with motion vector=(0,0) and “bottom field” backward referencing the “top field” with motion vector=(0,0).

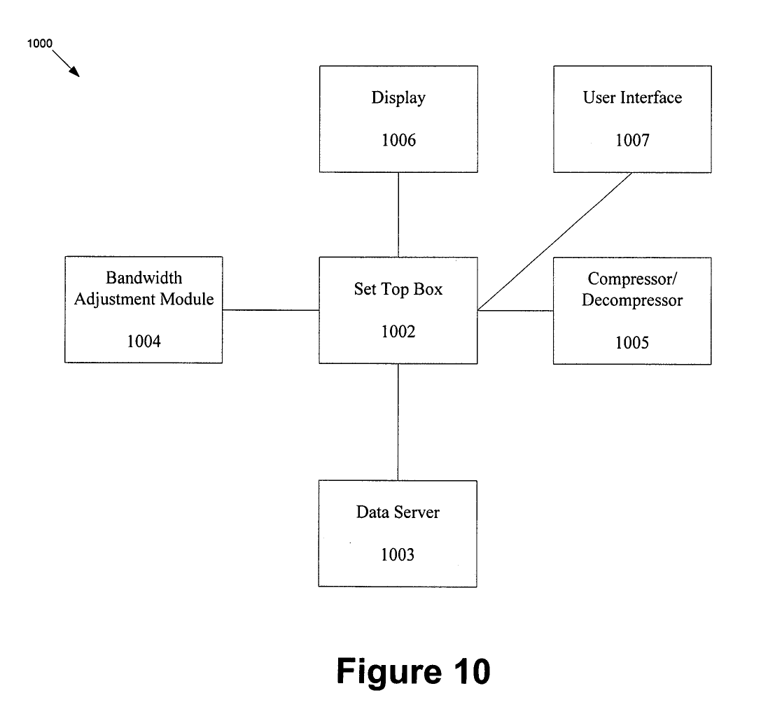

FIG. 10 illustrates a system 1000 for communicating a data stream. As shown in FIG. 10, a set-top box 1002 is in communication with a data server 1003 and with a bandwidth adjustment module 1004. Bandwidth adjustment module 1004 is capable of moving a portion of a data stream (e.g., a trickmode packet) to another timeslot when its designated timeslot is not sufficiently large to handle the data stream. The example trickmode packet may include a series of I-frames that may be communicated at a rate of approximatelylo frames per second. Also, bandwidth adjustment module 1004 may insert Dummy data (e.g., B-frames and P-frames) into the trickmode packet.

System 1000 also may include a compression/decompression coder 1005 in communication with set top box 1002. Compression/decompression coder 1005 may operate in accordance with MPEG standards. System 1000 also may include a display 1006 for displaying images from set top box 1002, and a user interface 1007 capable of communicating with set top box to initiate a trickmode play (e.g., fast forward, rewind, play, pause and stop). Display 1006 may be a conventional television set. User interface 1007 may communicate with set top box using wireless techniques. User interface 1007 may be a conventional remote control capable of communicating using a wireless link like infrared (IR), radio frequency (RF), or any other suitable type of link. The disclosed methods, devices, and systems may also be used with computers or portable or handheld devices capable of displaying video data, for example, personal digital assistants (PDAs), laptops, and mobile phones.

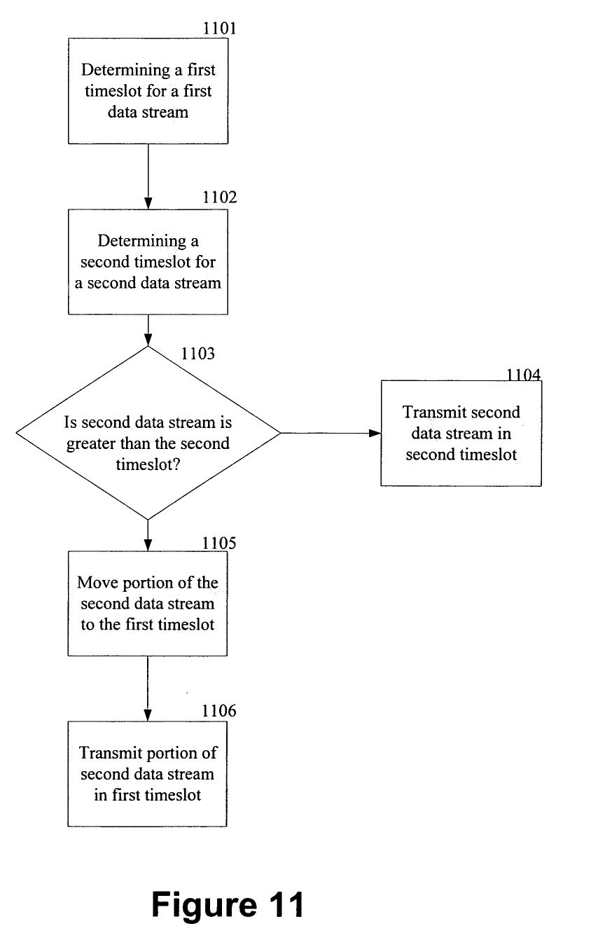

FIG. 11 is a flow diagram of a method of communicating a data stream. In 1101, a first timeslot of a first data stream and in 1102 a second timeslot of a second data stream. In 1103, it is determined whether the second data stream is greater than the second timeslot. If the second data stream is not greater than the second timeslot, in 1104 the second data stream is transmitted in the second timeslot. If, on the other hand, the second data stream is greater than the second timeslot, in 1105 a portion of the second data stream is moved to the first timeslot. In 1106, the second data stream is transmitted.

In addition, the described methods may further control an amount of data storage as a function of the moved portion and monitor a size of the second data stream and a size of the second timeslot. The methods may compress and decompress the data streams in accordance with MPEG standards, and operate to redistribute unused bandwidth in the first timeslot to the second timeslot. The described methods may monitor the data streams to determine a maximum rate for communicating the data streams.

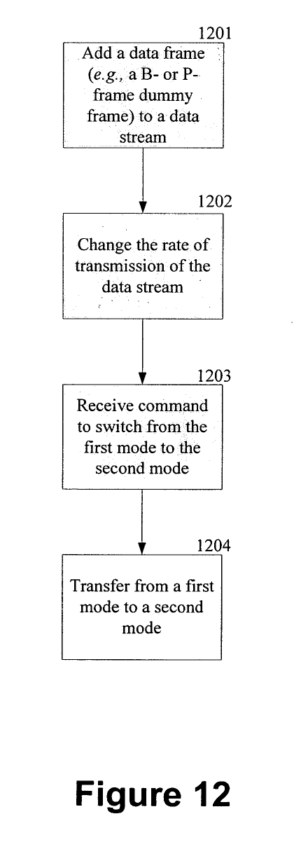

FIG. 12 is a flow diagram of a method for controlling a data storage or buffer level. In 1201, a data frame (e.g., a B- or P-frame dummy frame) is added to a data stream that comprises I-frames. In 1202, the rate of transmission the data stream is changed. In 1203, a command to switch from the first mode to the second mode is received and in 1204 a transfer is made from a first mode to a second mode. The first and second modes may be a trickmode play mode and/or a normal play mode.

The true scope of the disclosure is not limited to the illustrative embodiments disclosed herein. For example, the foregoing disclosure of various techniques for creating efficient trickmode playback may be used separately or in combination with each other. In addition, it should be appreciated that the disclosed embodiments operate over a wide variety of picture sizes (e.g., HDTV) and frame rates. It should be appreciated that the contemplated techniques allow smooth transitions between different play speeds and normal play speed without generating visual artifacts, black screens, underflow, macro-blocking that is typically associated to buffer overflow, or discontinuities commonly present in transitions executed without buffer management. Also, as part of the disclosed techniques, a different dummy B-frame and P-frame encoding may be used. For example, in some embodiments, rather than using frame predicted B-frames and P-frames as “no-motion” frames, as discussed, it is within the scope of the invention to use a different encoding. This may be provided for certain types of formats, like interlaced pictures for example.

Moreover, as will be understood by those skilled in the art, many of the inventive aspects disclosed herein may be applied in computer systems, as either software or hardware solutions, that are not employed for streaming media or video-on-demand purposes. Similarly, the embodiments are not limited to systems employing VOD concepts, or to systems employing specific types of computers, processors, switches, storage devices, memory, algorithms, etc. Given the rapidly declining cost of digital processing, networking and storage functions, it is easily possible, for example, to transfer the processing and storage for a particular function from one of the functional elements described herein to another functional element without changing the inventive operation of the system. In many cases, the place of implementation (i.e., the functional element) described herein is merely a designer's preference and not a hard requirement. Accordingly, except as they may be expressly so limited, the scope of protection is not intended to be limited to the specific embodiments described above.

What is claimed is:

1. A method of communicating a data stream, comprising:
determining a first timeslot of a first data stream;
determining a second timeslot of a second data stream;
moving a portion of the second data stream to the first timeslot when the second data stream is greater than the second timeslot.

2. The method of claim 1, further comprising controlling an amount of data storage as a function of the moved portion.

3. The method of claim 1, further comprising monitoring a size of the second data stream and a size of the second timeslot.

4. The method of claim 1, further comprising compressing and decompressing the data streams in accordance with Motion Picture Experts Group standards.

5. The method of claim 1, wherein the first and second data stream are trickmode streams.

6. The method of claim 1, wherein the data packet is a trickmode packet.

7. The method of claim 1, further comprising redistributing unused bandwidth in the first timeslot to the second timeslot.

8. The method of claim 1, wherein the method is performed by a computer-readable medium having computer-executable instructions.

9. The method of claim 1, further comprising providing a fixed-length timeslot.

10. The method of claim 1, further comprising monitoring the data streams to determine a maximum rate for communicating the data streams.

11. A system for communicating a data stream, comprising:
a set top box;
a data server in communication with the set top box;
a bandwidth adjustment module in communication with the set top box and the data server, wherein the bandwidth adjustment module is capable of moving a portion of a second data stream to a first timeslot when the second data stream is greater than a second timeslot.

12. The system of claim 11, wherein the second data stream is a trickmode packet.

13. The system of claim 12, wherein the trickmode packet comprises I-frames.

14. The system of claim 13, wherein the I-frames are communicated at a rate of 10 frames per second.

15. The system of claim 12, wherein the bandwidth adjustment module inserts Dummy data into the trickmode packet.

16. The system of claim 15, wherein the Dummy data comprises B-frames and P-frames.

17. The system of claim 11, further comprising a compression/decompression decoder.

18. The system of claim 17, wherein the compression/decompression decoder operates in accordance with Motion Picture Experts Group standards.

19. The system of claim 11, further comprising a user interface capable of communicating with the set top box to initiate a trickmode play.

20. The system of claim 19, wherein the user interface is wireless.

21. The system of claim 19, wherein the trickmode play includes at least one of the following: fast forward, rewind, play, pause and stop.

22. The system of claim 11, wherein the data server provides video streams.

23. The system of claim 11, further comprising a display device in communication with the set top box.

24. A method of controlling a data storage level, comprising:
adding a data frame to a data stream;
changing the rate of transmission the data stream; and
transferring from a first mode to a second mode.

25. The method of claim 24, further comprising receiving a command to switch from the first mode to the second mode.

26. The method of claim 24, further comprising compressing and decompressing the data stream in accordance with Motion Pictures Expert Group standards.

27. The method of claim 24, wherein the data frame is a dummy frame.

28. The method of claim 27, wherein dummy frame is at least one of the following: a B-frame and a P-frame.

29. The method of claim 27, wherein the data stream comprises an I-frame.

30. The method of claim 24, wherein the data stream is a video stream.

31. The method of claim 25, wherein the modes are at least one of the following: a trickmode play and a normal play mode.

32. The method of claim 25, further comprising consecutively displaying substantially similar frames.
